(19) United States
(12) Patent Application Publication
(10) Pub. No.: US 2021/0341628 A1
(43) Pub. Date: Nov. 4, 2021

(54) INFORMATION COLLECTION APPARATUS AND UNMANNED AERIAL VEHICLE IN WHICH THE INFORMATION COLLECTION APPARATUS IS INSTALLED

(71) Applicant: TERRA DRONE CORPORATION, Tokyo (JP)

(72) Inventor: Taro SUZUKI, Tokyo (JP)

(73) Assignee: TERRA DRONE CORPORATION, Tokyo (JP)

(21) Appl. No.: 16/470,399

(22) PCT Filed: Apr. 19, 2019
(86) PCT No.: PCT/JP2019/016882

§ 371 Date: Jun. 17, 2019

(30) Foreign Application Priority Data
Jul. 6, 2018 (JP) 2018-129550

(51) Int. Cl. G01S 19/36; H01Q 1/28; G01S 19/53; B64C 39/02

(52) U.S. Cl. CPC G01S 19/36; H01Q 1/28; G01S 19/54; B64C 39/024; G01S 19/53

(57) ABSTRACT

An information collection apparatus collects information items about a position and a posture while flying in the air under a state of being attached to a drone. The information collection apparatus includes: six receivers, each of which receives location signals that are broadcasted from a plurality of satellites; and a frame to which six antennas of the six receivers are fixed. The six antennas of the six receivers, which receive the location signals, are arranged in an annular array and at equal intervals. The six receivers each receive the location signals that are broadcasted from the satellites. Thus, even without use of an IMU, by using these signals received by the receivers, the position and the posture can be estimated with high accuracy.

### TECHNICAL FIELD

The present disclosure relates to an information collection apparatus and an unmanned aerial vehicle in which the information collection apparatus is installed. More specifically, the present disclosure relates to an information collection apparatus to be used for surveying.

### BACKGROUND ART

General aerial surveying includes capturing the ground with a camera or a line sensor installed in an aircraft, and generating a map from taken images (refer, for example, to Patent Literature 1 below). Further, in recent years, aerial surveying including using UAVs (unmanned aerial vehicles) such as a drone has been put to practical use.

### CITATION LIST

### Patent Literature

PTL 1: Japanese Patent Application Laid-Open No. 10-153426

### SUMMARY OF INVENTION

### Technical Problem

In order to generate an accurate map from the images of the ground, which are taken with use of the UAVs, in general, it is necessary to set markers called GCPs (ground control points) on the ground in advance, and to correct the map by utilizing position information items of the GCPs depicted in the images. Thus, there are problems such as time and effort in setting the GCPs, and incompatibility with environments where the GCPs cannot be set.

Meanwhile, in recent years, a method of measuring a distance from the UAV to the ground with use of a laser scanner installed in the UAV has been put to practical use. This method enables surveying to be conducted without the setting of the GCPs, but it is required to estimate a position and a posture of the UAV with high accuracy. At least the accuracy in estimating the position and the posture can be increased by using a high-accuracy GNSS (global navigation satellite system) receiver and a high-accuracy IMU (inertial measurement unit). However, when such high-accuracy devices are used, there arises a problem of an increase in manufacturing cost. Further, these devices are different from each other in measurement principle, and different from each other in point of consideration to exhibit desired performance. Thus, when both the GNSS receiver and the IMU are installed in the UAV for the measurement, there is a problem of difficulties in satisfying performance demands for both the devices in various measurement environments. In addition, data items to be measured by the GNSS receiver and the IMU are different from each other in property, and hence there is another problem of complication of data processing.

In view of such circumstances, the present disclosure has been made to achieve an object to provide an information collection apparatus and an unmanned aerial vehicle, the information collection apparatus being capable of obtaining observation data items for estimating a position and a posture with high accuracy, and being manufactured at low cost, the unmanned aerial vehicle including such an information collection apparatus.

### Solution to Problem

A first aspect of the present disclosure relates to an information collection apparatus that collects information items about a position and a posture. This information collection apparatus includes:

“N” (N is an integer number of three or more) receivers, the “N” receivers each receiving location signals that are broadcasted from a plurality of satellites; and

a frame to which “N” antennas of the “N” receivers are fixed.

The “N” antennas of the “N” receivers receive the location signals, and are arranged in an annular array and at equal intervals.

The frame includes
a body portion, and
“N” arm portions, the “N” arm portions each extending in a direction away from a virtual center line that extends through the body portion.

The “N” antennas are fixed respectively to one ends of the “N” arm portions, the one ends being away from the body portion.

The body portion includes
a body frame that supports other ends of the “N” arm portions,
a mobile-body coupling portion that is coupled in an attachable/detachable manner to a mobile body that is located on the virtual center line, and
a vibration-damping portion that is fixed to the body frame and the mobile-body coupling portion, and that suppresses transmission of vibration from the mobile-body coupling portion to the body frame.

The “N” antennas are located in a common virtual plane perpendicular to the virtual center line, and

the common virtual plane is spaced away from the mobile body under a state of being coupled to the mobile-body coupling portion.

When the virtual center line is parallel to a vertical direction, and at a same time, when the common virtual plane is located above the mobile body, the body frame is suspended from the mobile body through intermediation of the vibration-damping portion and the mobile-body coupling portion.

A second aspect of the present disclosure relates to an unmanned aerial vehicle in which the information collection apparatus according to the first aspect is installed.

### Advantageous Effects of Invention

According to the aspects of the present disclosure, it is possible to provide an information collection apparatus and an unmanned aerial vehicle, the information collection apparatus being capable of obtaining observation data items for estimating a position and a posture with high accuracy, and being manufactured at low cost, the unmanned aerial vehicle including such an information collection apparatus.

### BRIEF DESCRIPTION OF DRAWINGS

FIG. 1 is a diagram showing an example of a configuration of a system according to an embodiment of the present disclosure.

FIG. 2A and FIG. 2B are views illustrating an example of a UAV in which an information collection apparatus is installed.

FIG. 3 is a diagram showing an example of a configuration of the information collection apparatus.

FIG. 4 is a diagram showing an example of a configuration of an information processing apparatus.

FIG. 5 is an explanatory flowchart showing operations of generating a three-dimensional map by collecting information items with use of the information collection apparatus installed in the UAV.

FIG. 6 is a perspective view illustrating an example of the UAV according to the embodiment.

FIG. 7 is a perspective view illustrating the information collection apparatus installed in the UAV illustrated in FIG. 6.

FIG. 8 is an enlarged perspective view in which a body portion of the information collection apparatus is viewed from above.

FIG. 9 is an enlarged perspective view in which the body portion of the information collection apparatus is viewed from below.

FIG. 10 is a perspective view illustrating a state in which one of arm portions is folded.

FIG. 11 is an enlarged perspective view of a vibration-damping portion and a mobile-body coupling portion of the body portion.

FIG. 12 is an enlarged perspective view of a vicinity of a bar-like-member coupling portion of the arm portion, which illustrates a state in which a first bar-like member and a second bar-like member are coupled to each other with the bar-like-member coupling portion.

FIG. 13 is another enlarged perspective view of the vicinity of the bar-like-member coupling portion of the arm portion, which illustrates a state in which the first bar-like member and the second bar-like member are separated from each other.

FIG. 14 is a view illustrating a state in which the arm portions of the information collection apparatus are folded.

### DESCRIPTION OF EMBODIMENTS

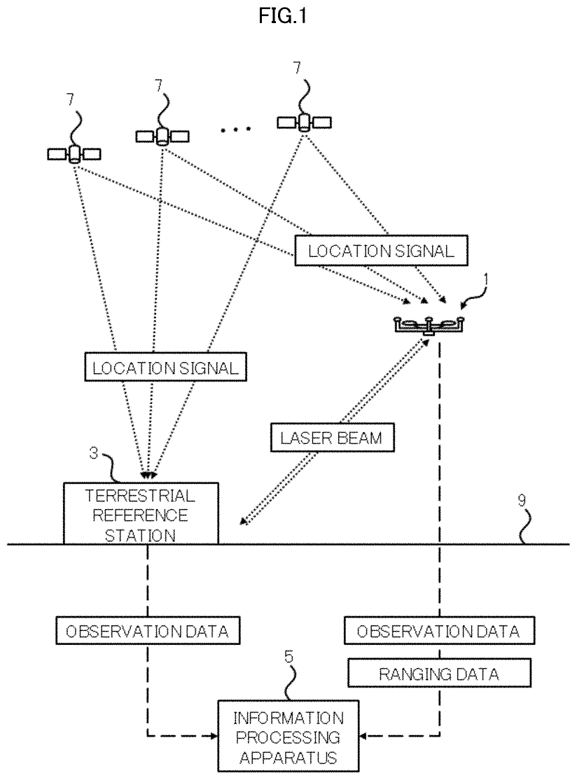

FIG. 1 is a diagram showing an example of a configuration of a system according to an embodiment of the present disclosure. In the system according to this embodiment, a UAV (unmanned aerial vehicle) 1 as a mobile body periodically receives location signals that are broadcasted from a plurality of satellites 7. With this, a position and a posture of the UAV 1 are estimated, and a distance and a direction from the UAV 1 to a ground surface 9 are measured in synchronization with reception timings of the signals. This system collects results of the estimation of the position and the posture of the UAV 1, and results of the measurement of the distance and the direction from the UAV 1 to the ground surface 9. With this, this system generates a three-dimensional map of the ground surface 9.

The system shown in the example of FIG. 1 includes an information processing apparatus 5. The information processing apparatus 5 receives an observation data item and a ranging data item that are acquired by the UAV 1 that flies in the air, and an observation data item that is acquired by a terrestrial reference station 3 installed on the ground, and processes these data items. In this way, the information processing apparatus 5 generates the three-dimensional map of the ground surface 9.

The observation data items that are acquired by the UAV 1 and the terrestrial reference station 3 are data items to be generated based on the location signals that are broadcasted from the plurality of satellites 7. The observation data items include information items about distances from the plurality of satellites 7 (distances from satellites 7 to antennas). As described below, the UAV 1 includes a plurality of receivers, and hence the observation data item that is acquired by the UAV 1 includes observation data items generated by the plurality of receivers. Further, the ranging data item that is acquired by the UAV 1 includes a measured value of the distance from the UAV 1 to the ground surface 9, and an information item about the measurement direction as viewed from the UAV 1 at the time of measuring the distance. The ranging data item includes the measured value of the distance, which is obtained based on a reflected light beam of a laser beam applied to the ground surface 9 as shown in FIG. 1, and an information item about an irradiation direction of the laser beam. The observation data items that are acquired by the UAV 1 and the terrestrial reference station 3, and the ranging data item that is acquired by the UAV 1 are acquired substantially at the same time point at respective predetermined intervals (at intervals of, for example, one second).

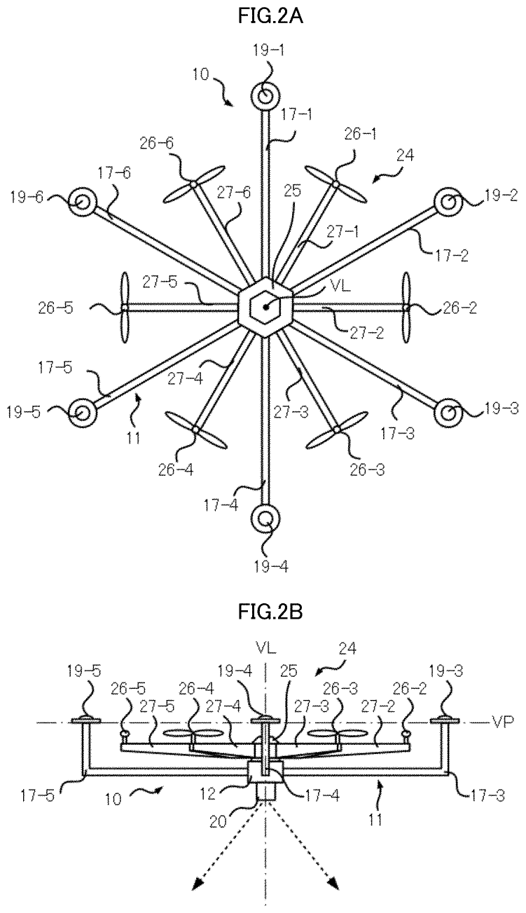

FIG. 2A and FIG. 2B are views illustrating an example of the UAV 1 in which an information collection apparatus is installed. FIG. 2A is a plan view, and FIG. 2B is a front view. The UAV 1 illustrated in FIG. 2A and FIG. 2B includes a propeller-type drone 24 and an information collection apparatus 10 coupled to the drone 24. The drone 24 includes a body portion 25, six arm portions 27-1 to 27-6 (below, sometimes collectively referred to as “arm portions 27”), each of which extends in a direction away from a virtual center line VL that extends through the body portion 25, and six propellers 26-1 to 26-6 (below, sometimes collectively referred to as “propellers 26”) provided respectively at one ends of the arm portions 27-1 to 27-6. As illustrated in FIG. 2A, as viewed in a direction parallel to the virtual center line VL, the six propellers 26 are arranged in an annular array and at equal intervals around the virtual center line VL.

The information collection apparatus 10 includes six antennas 19-1 to 19-6 (below, sometimes collectively referred to as “antennas 19”), each of which receives the location signals from the satellites 7, and a frame 11 to which the six antennas 19 are fixed. As illustrated in FIG. 2A, as viewed in the direction parallel to the virtual center line VL, the six antennas 19 are arranged in an annular array and at equal intervals around the virtual center line VL.

The frame 11 includes a body portion 12 and six arm portions 17-1 to 17-6 supported by the body portion 12 (below, sometimes collectively referred to as “arm portions 17”). The virtual center line VL extends through the body portion 12, and the six arm portions 17 each extend in a direction away from the virtual center line VL. The antennas 19 are fixed respectively to one ends of the arm portions 17, which are away from the body portion 12. In the example of FIG. 2B, the arm portions 17 each extend in a horizontal direction from the body portion 12, and are each partway bent upward in an L-shape with respect to the horizontal direction. The antennas 19, each of which has a disk shape, are fixed to respective distal ends of the upward extending parts of the arm portions 17. The six antennas 19 are located in a common virtual plane VP perpendicular to the virtual center line VL.

As illustrated in FIG. 2A, as viewed in the direction parallel to the virtual center line VL, the arm portions 17 each extend in a direction that substantially bisects an angle formed between adjacent two of the arm portions 27. The six antennas 19 fixed to the one ends of the arm portions 17 are farther from the virtual center line VL than the propellers 26 of the drone 24 are, and located above the propellers 26. The body portion 12 of the information collection apparatus 10 is coupled to a bottom surface of the body portion 25 of the drone 24. The information collection apparatus 10 is suspended from the drone 24, and in this state, flies together with the drone 24. A ranging apparatus 20 is attached to a bottom surface of the body portion 12 of the information collection apparatus 10, and the ranging laser beam is applied from the ranging apparatus 20 toward the ground surface 9.

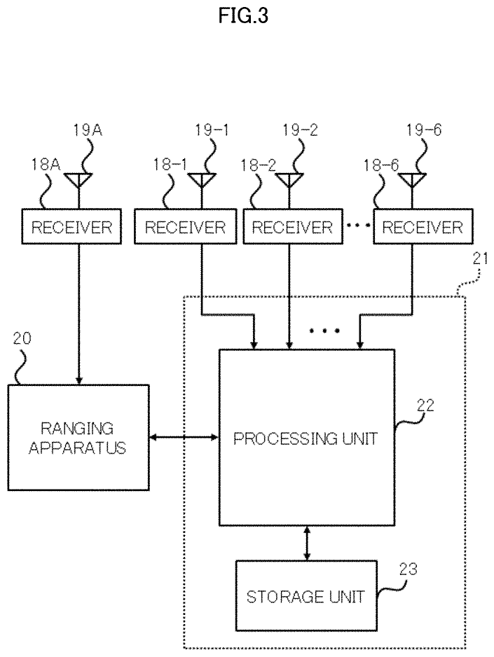

FIG. 3 is a diagram showing an example of a configuration of the information collection apparatus 10 installed in the UAV 1. The information collection apparatus 10 shown in FIG. 3 includes six receivers 18-1 to 18-6 (below, sometimes collectively referred to as “receivers 18”) that are used for estimating the position and the posture, the ranging apparatus 20, a receiver 18A that is used for setting a measurement timing of the ranging apparatus 20, and a control apparatus 21.

The receivers 18 receive, via the antennas 19, the signals that are broadcasted from the satellites 7. The receivers 18 receive the location signals that are broadcasted from the plurality of satellites 7, and generate, based on these received signals, the observation data items including the information items about the distances between the satellites 7 and reception positions of the antennas 19, at which the location signals are received. The observation data items include information items about carrier phases of the signals broadcasted from the plurality of satellites 7. The receivers 18 periodically receive the signals from the satellites 7 (at the intervals of, for example, one second) at timings in synchronization with system clocks precisely controlled in the satellites 7, and generate the observation data items.

The receiver 18A receives, via an antenna 19A, the signals that are broadcasted from the satellites 7. The receiver 18A outputs, in response to the received signals from the satellites 7, signals that signify the periodical reception timings in synchronization with the above-mentioned system clocks to the ranging apparatus 20.

The ranging apparatus 20, which is located at a reference point for the estimation of the position of the UAV 1, measures a distance from the reference point to a target. The ranging apparatus 20, which is, for example, a laser scanner, measures the distance between one point on the ground surface 9 and the reference point based, for example, on a phase and a time interval of the reflected light beam of the laser beam applied to the one point on the ground surface 9. The ranging apparatus 20 scans the ground surface 9 with the laser beams so as to measure distances to a large number of positions on the ground surface 9. Based on the signals that are output from the receiver 18A, which signify the reception timings, the ranging apparatus 20 measures the distances at the timings in synchronization with the reception of the signals from the satellites 7 by the six receivers 18. The ranging apparatus 20 generates the ranging data items including the measured values of the distances, and the information items about the measurement directions (irradiation directions of the laser beams).

The control apparatus 21 records the observation data items generated by the receivers 18-1 to 18-6, and the ranging data items generated by the ranging apparatus 20. In the example of FIG. 3, the control apparatus 21 includes a processing unit 22 and a storage unit 23. The processing unit 22 correlates ones of the observation data items obtained by the six receivers 18-1 to 18-6, and one of the ranging data items obtained by the ranging apparatus 20 to each other, the ones of these data items being obtained at the same time point, and records these data items to the storage unit 23. In this way, sets of the observation data items and the ranging data items obtained at the same time points are accumulated in an order of the time points in the storage unit 23.

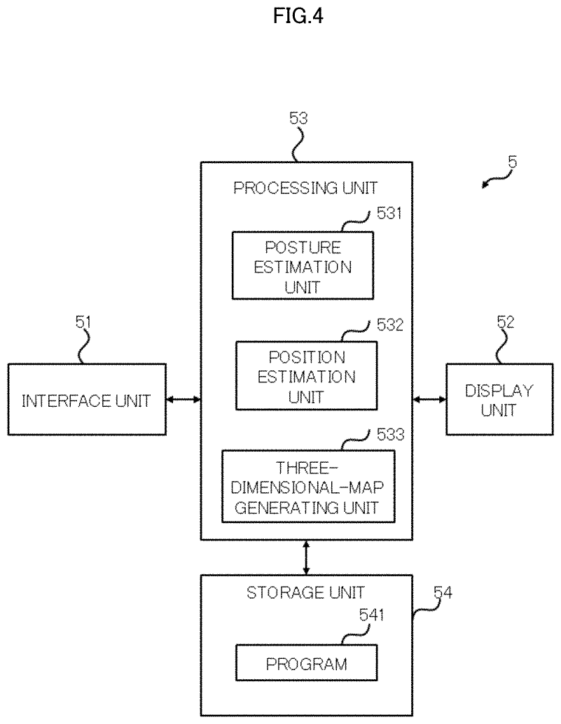

FIG. 4 is a diagram showing an example of a configuration of the information processing apparatus 5. The information processing apparatus 5 shown in FIG. 4 includes an interface unit 51, a display unit 52, a processing unit 53, and a storage unit 54.

The interface unit 51 includes user interface devices (such as a keyboard, a mouse, a touchpad, and a touchscreen) for allowing information items in response to operations by a user to be input to the processing unit 53. Further, the interface unit 51 also includes a communication interface for exchanging the information items between external devices and the processing unit 53, general-purpose input/output interfaces such as a USB, and a recording-medium reading apparatus.

The display unit 52, which is an apparatus that displays videos under control by the processing unit 53, includes a display apparatus (such as liquid-crystal display or OLED display).

The processing unit 53, which is an apparatus that executes various information processes, includes a computer that executes processes in accordance with instruction codes of a program 541 that is stored in the storage unit 54. The processing unit 53 may execute at least some of the processes with dedicated hardware.

In the example of FIG. 4, the processing unit 53 includes a posture estimation unit 531, a position estimation unit 532, and a three-dimensional-map generating unit 533. The processing unit 53 receives, via the interface unit 51, the data items (observation data items and ranging data items) accumulated in the storage unit 23 of the information collection apparatus 10 (FIG. 3), and uses these data items for processes in the units therein (posture estimation unit 531, position estimation unit 532, and three-dimensional-map generating unit 533).

The posture estimation unit 531 estimates the posture of the UAV 1 based on the observation data items generated based on the signals that the six receivers 18 installed in the UAV 1 have received from the plurality of satellites 7, and based on position data items of the plurality of satellites 7. The position data items, which are data items including information items about positions of the satellites 7 at each time point, which move in their predetermined respective orbits, are acquired based on published known information items.

The position estimation unit 532 estimates, based on the observation data items and the position data items described above, a position of the reference point in the UAV 1. Specifically, the position estimation unit 532 calculates, based on the position data items and the observation data items, “estimated reception positions PE” at which the one or more receivers 18 are estimated to receive the signals from the satellites 7 via the antennas 19. The position estimation unit 532 calculates an estimated position PX of the reference point in the UAV 1 based on the posture of the UAV 1, which is estimated by the posture estimation unit 531, and on the calculated one or more estimated reception positions PE.

The three-dimensional-map generating unit 533 acquires, at each of the time points, the posture of the UAV 1, which is estimated by the posture estimation unit 531, the estimated position PX of the reference point, which is estimated by the position estimation unit 532, the distance measured value of the ranging apparatus 20, and the information item about the irradiation direction of the laser beam from the ranging apparatus 20. Based on these data items acquired at each of the time points, the three-dimensional-map generating unit 533 calculates three-dimensional coordinates of each of the positions on the ground surface 9.

The storage unit 54 stores, for example, the program 541 that is executed by the computer of the processing unit 53, data items that are temporarily stored in the course of the processes by the processing unit 53, and constants that are utilized in the processes by the processing unit 53. The storage unit 54 includes one or more arbitrary storage apparatus such as a ROM, a RAM, a flash memory, a hard disk, and a magnetic recording medium.

Next, an overview of operations in the system having the above-described configuration is described.

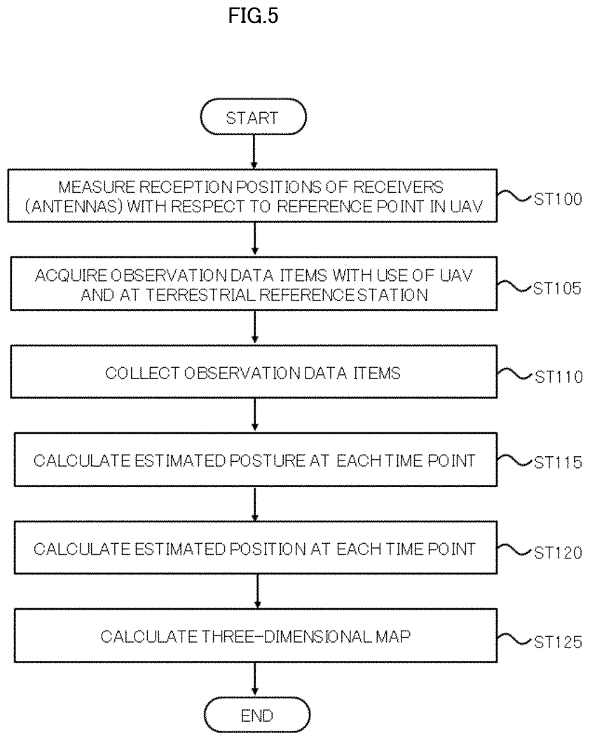

FIG. 5 is an explanatory flowchart showing operations of generating the three-dimensional map by collecting the information items with use of the information collection apparatus 10 installed in the UAV 1.

First, the reception positions at which the receivers 18 of the UAV 1 receive the signals from the satellites 7 (reception positions of the antennas 19, at which the signals are received) are measured (ST100). The reception positions of the receivers 18 are precisely measured as relative positions with respect to the reference point (laser-beam emitting position of the ranging apparatus 20). The reception positions of the receivers 18 are used not only as references at the time of calculating the estimated posture, but also for determining whether or not the estimated position calculated based on the observation data items is proper.

Then, the UAV 1 is flown, and the information collection apparatus 10 installed in the UAV 1 collects the information items (ST105). Specifically, the information collection apparatus 10 performs, periodically and at the same timings, the signal reception by the six receivers 18, and the distance measurement by the ranging apparatus 20. The information collection apparatus 10 accumulates, as data items in time series, the sets of the observation data items and the ranging data items obtained at the same timings.

Further, while the information collection apparatus 10 of the UAV 1 collects the information items, the terrestrial reference station 3 (FIG. 1) also receives the signals from the satellites 7. The terrestrial reference station 3 may be installed by a public institution, or may be installed by the user himself/herself. The terrestrial reference station 3 receives the signals from the satellites 7 at a place from which the position have been precisely measured in advance, and generates the observation data items including the information items about the distances to the satellites 7.

After desired information items are collected by the information collection apparatus 10, the information items (observation data items and ranging data items) collected by the information collection apparatus 10 are collected, and then input to the information processing apparatus 5. Further, the observation data items obtained by the terrestrial reference station 3, and the position data items indicating the positions of the satellites 7 at each of the time points are also input to the information processing apparatus 5 (ST110).

Based on the observation data items generated by the six receivers 18 and collected by the information collection apparatus 10, and on the position data items of the satellites 7, the posture estimation unit 531 of the information processing apparatus 5 calculates the estimated posture of the UAV 1 at each of the time points (ST115).

Next, based on the observation data items generated by the six receivers 18 and collected by the information collection apparatus 10, on the position data items of the satellites 7, on the observation data items obtained by the terrestrial reference station 3, and on the already-calculated estimated posture of the UAV 1, the position estimation unit 532 of the information processing apparatus 5 calculates the estimated position PX of the reference point in the UAV 1 (ST120).

Based on the estimated posture of the UAV 1, on the estimated position PX of the reference point, and on the ranging data item (measured value of the distance and irradiation direction of the laser beam) at the same time point, the three-dimensional-map generating unit 533 of the information processing apparatus 5 calculates three-dimensional coordinates of one point on the ground surface 9. By collecting the three-dimensional coordinates on the ground surface 9, which are calculated at each of the time points, a three-dimensional data item (three-dimensional map) within a certain range on the ground surface 9 is obtained (ST125).

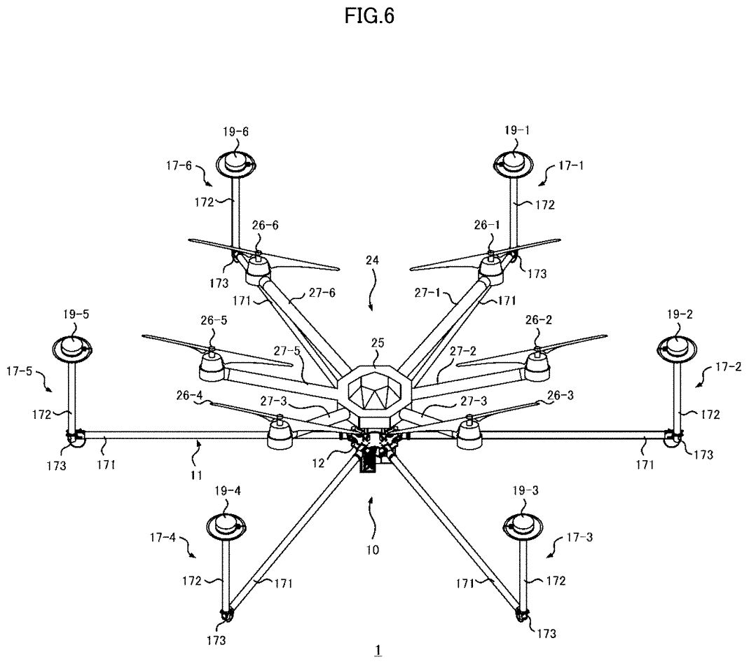

Next, a structure of the information collection apparatus 10 according to this embodiment is described in more detail with reference to FIG. 6 to FIG. 14.

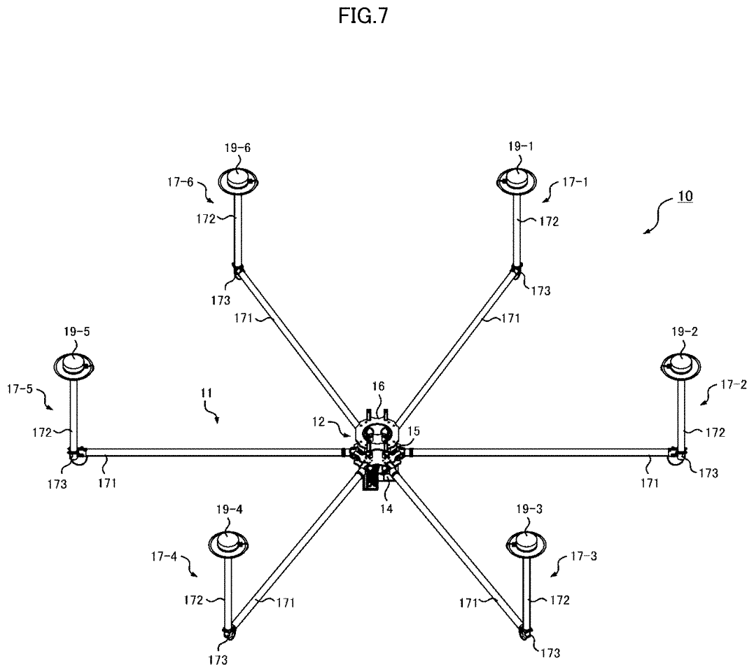

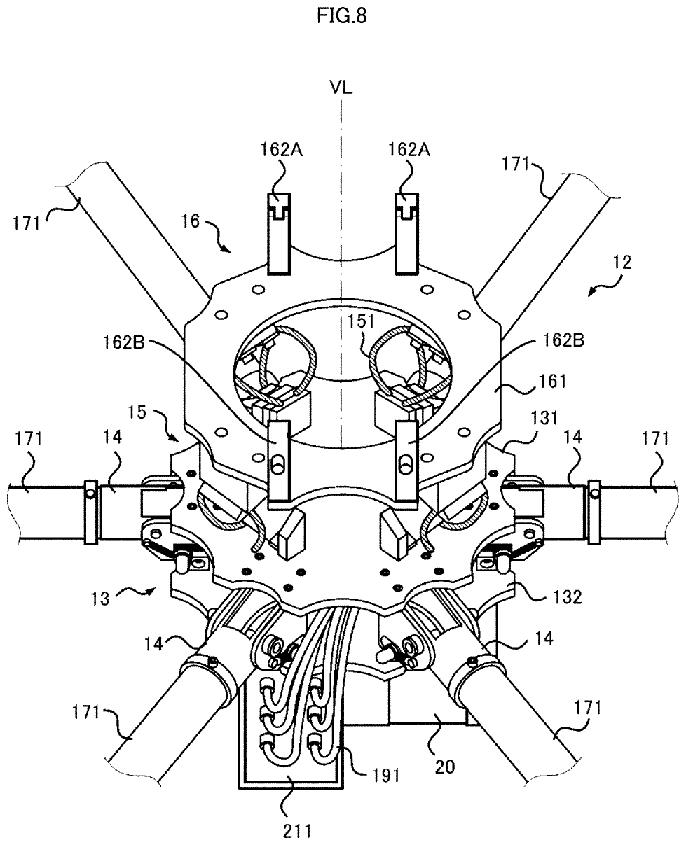

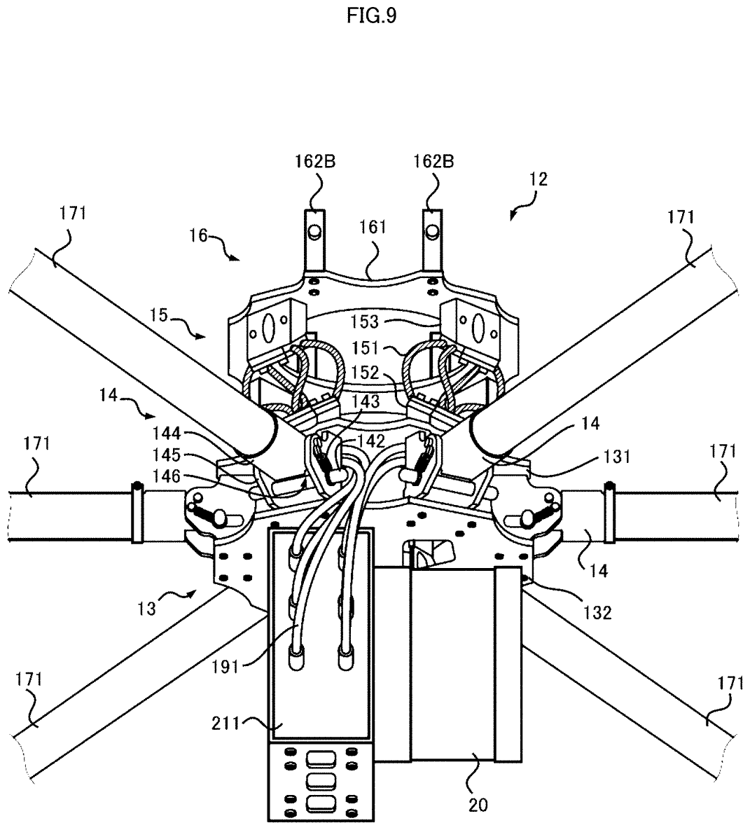

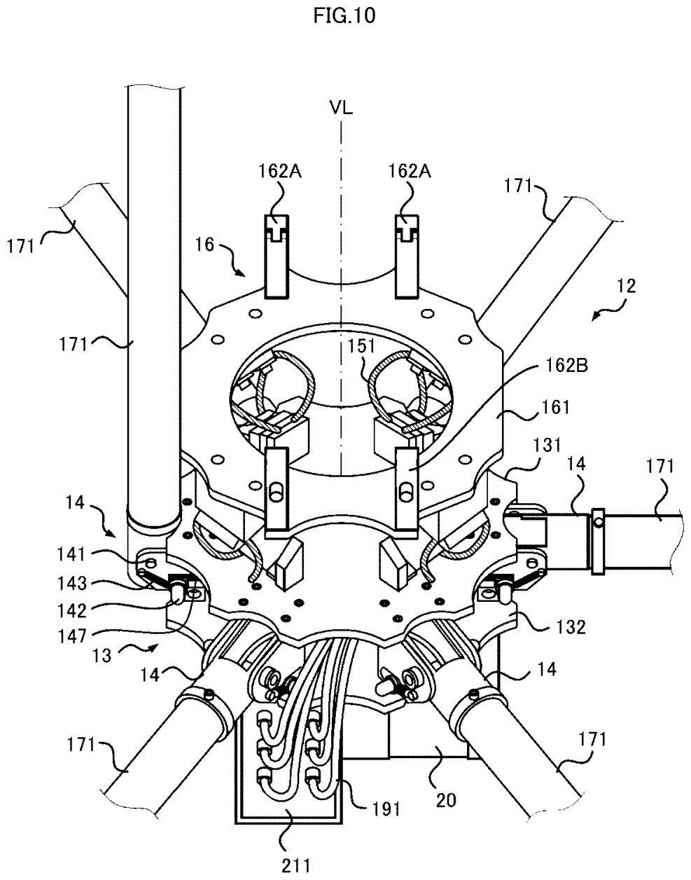

FIG. 6 is a perspective view illustrating an example of the UAV 1 according to this embodiment. FIG. 7 is a perspective view illustrating the information collection apparatus 10 installed in the UAV 1 illustrated in FIG. 6. FIG. 8 is an enlarged perspective view in which the body portion 12 of the information collection apparatus 10 is viewed from above. FIG. 9 is an enlarged perspective view in which the body portion 12 is viewed from below. FIG. 10 is a perspective view illustrating a state in which one of the arm portions 17 is folded in the body portion 12.

As illustrated in FIG. 7 to FIG. 9, the body portion 12 of the frame 11 includes a body frame 13 that supports other ends of the six arm portions 17, a mobile-body coupling portion 16 that is coupled in an attachable/detachable manner to the drone 24 (mobile body), and a vibration-damping portion 15 that suppresses transmission of vibration from the mobile-body coupling portion 16 to the body frame 13.

As illustrated in FIG. 8 and FIG. 9, the body frame 13 includes a first plate-like member 131 and a second plate-like member 132 arranged to face each other, and six arm-portion support mechanisms 14 arranged between the first plate-like member 131 and the second plate-like member 132.

As illustrated in FIG. 9, the ranging apparatus 20 and a control apparatus casing 211 are attached to the second plate-like member 132 of the body frame 13. The control apparatus casing 211 contains the control apparatus 21 and the receivers 18-1 to 18-6. The antennas 19 attached respectively to the one ends of the arm portions 17 are connected respectively to the receivers 18 in the control apparatus casing 211 with cables 191. Between the antennas 19 and the body portion 12, the cables 191 extend through tubular members (first bar-like member 171 and second bar-like member 172 described below) of the arm portions 17.

The six arm-portion support mechanisms 14 of the body frame 13 respectively support the other ends of the arm portions 17. As illustrated in FIG. 10, the arm-portion support mechanisms 14 each support the other end of the arm portion 17 in a pivotal manner such that an angle of the arm portion 17 with respect to the virtual center line VL can be varied. When the angle of the arm portion 17 with respect to the virtual center line VL reaches a predetermined angle (approximately 90° in the example of FIG. 2B), the arm-portion support mechanism 14 enters a locking state in which the arm portion 17 is stopped from pivoting. This locking state can be switched to a state of being cancelled by an operation by the user (unlocking state). When the six arm-portion support mechanisms 14 are held in the locking state, as illustrated in FIG. 2A, the six antennas 19 are arranged in an annular array, and as illustrated in FIG. 2B, the six antennas 19 are located in the virtual plane VP.

In the example of FIG. 9 and FIG. 10, the arm-portion support mechanisms 14 each include a support 145 fixed to the first plate-like member 131 and the second plate-like member 132, a bar holder 144 that holds the other end of the arm portion 17 (one end of the first bar-like member 171 described below), and a shaft 141 that supports the bar holder 144 in a pivotal manner with respect to the support 145. The support 145 includes two wall portions that face each other with the bar holder 144 being interposed therebetween, and the shaft 141 is supported by these two wall portions. The bar holder 144 is guided along a pivotal direction by the two wall portions, and is suppressed from backlashing in a direction parallel to the shaft 141.

The arm-portion support mechanisms 14 each include an engaging pin 142 for stopping the bar holder 144 from pivoting with respect to the support 145. The engaging pin 142 is arranged through the two wall portions of the support 145. Both ends of the engaging pin 142 are movable along long holes 147 provided through the wall portions, and are each biased by a spring (elastic member) 143 toward one end of corresponding one of the long holes 147. When the angle of the arm portion 17 (first bar-like member 171) with respect to the virtual center line VL reaches the predetermined angle (approximately 90°), the engaging pin 142 is held at the one end of the long hole 147 by a biasing force of the spring 143. In this state, the engaging pin 142 slides into an engaging groove 146 of the bar holder 144, and the state (locking state) in which the bar holder 144 is prevented from pivoting with respect to the support 145 is reached. When the engaging pin 142 is moved toward other ends of the long holes 147 against the biasing force of the springs 143, the engaging pin 142 is disengaged from the engaging groove 146 of the bar holder 144. With this, the state (unlocking state) in which the bar holder 144 is allowed to pivot with respect to the support 145 is reached.

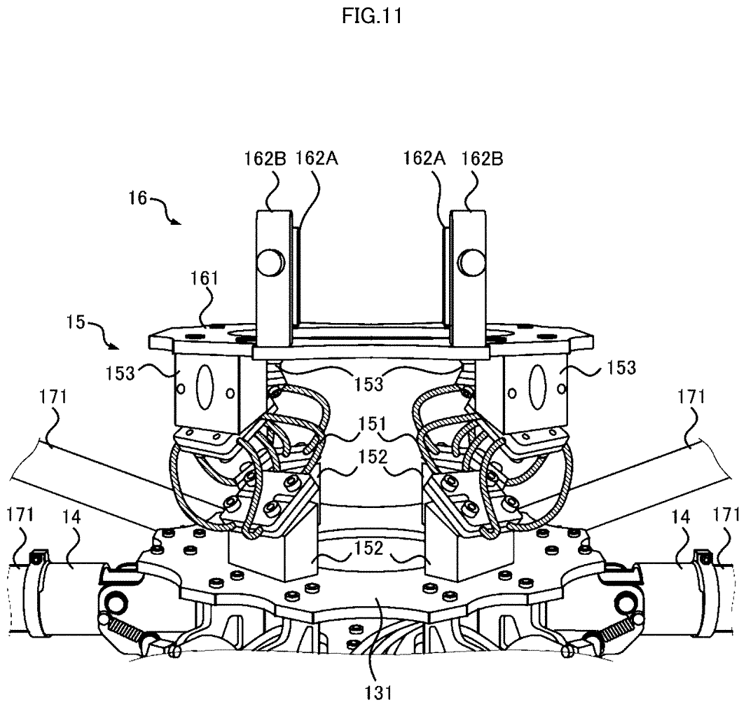

FIG. 11 is an enlarged perspective view of the vibration-damping portion 15 and the mobile-body coupling portion 16 of the body portion 12.

The mobile-body coupling portion 16 has a structure that is coupled in the attachable/detachable manner to the drone 24 located on the virtual center line VL (FIG. 2B). As illustrated in FIG. 8, FIG. 10, and FIG. 11, the mobile-body coupling portion 16 includes two pairs of couplers 162A and 162B that are coupled to two bar-like members provided on the bottom surface of the body portion 25 of the drone 24. The two couplers 162A are coupled to two points of one of the bar-like members, and the two couplers 162B are coupled to two points of another one of the bar-like members.

As illustrated in FIG. 11, the mobile-body coupling portion 16 includes a third plate-like member 161 arranged to face the first plate-like member 131 of the body frame 13. The above-mentioned two pairs of couplers 162A and 162B are fixed to a surface on one side of the third plate-like member 161 (surface on a side opposite to a surface that faces the first plate-like member 131).

As illustrated in FIG. 2B, the drone 24 coupled to the mobile-body coupling portion 16 are spaced away from the virtual plane VP in which the six antennas 19 are located. Thus, when the drone 24 flies under a state of being located below the virtual plane VP, the six antennas 19 are located above the drone 24. With this, the signals that are transmitted from the satellites to the antennas 19 are not blocked, for example, by the propellers 26 of the drone 24.

The vibration-damping portion 15, which is fixed to the first plate-like member 131 of the body frame 13 and the third plate-like member 161 of the mobile-body coupling portion 16, suppresses the transmission of the vibration from the third plate-like member 161 to the first plate-like member 131. As illustrated in FIG. 11, the vibration-damping portion 15 includes a plurality of wires 151 (sixteen wires 151 in the example of FIG. 11) that connect the first plate-like member 131 of the body frame 13 and the third plate-like member 161 of the mobile-body coupling portion 16 to each other. The wires are fixed to the first plate-like member 131 by wire fasteners 152, and fixed to the third plate-like member 161 by wire fasteners 153. The plurality of wires 151 may be connected to each other in the wire fasteners 152 and 153.

As illustrated in FIG. 7, the arm portions 17, which are supported by the body frame 13, each include the first bar-like member 171 extending parallel to the virtual plane VP, the second bar-like member 172 extending perpendicular to the virtual plane VP, and a bar-like-member coupling portion 173 that couples the first bar-like member 171 and the second bar-like member 172 to each other in the L-shape. The one end of the first bar-like member 171 is supported by the arm-portion support mechanism 14 of the body portion 12. The antenna 19 is fixed to one end of the second bar-like member 172. Another end of the first bar-like member 171 and another end of the second bar-like member 172 are coupled to each other with the bar-like-member coupling portion 173.

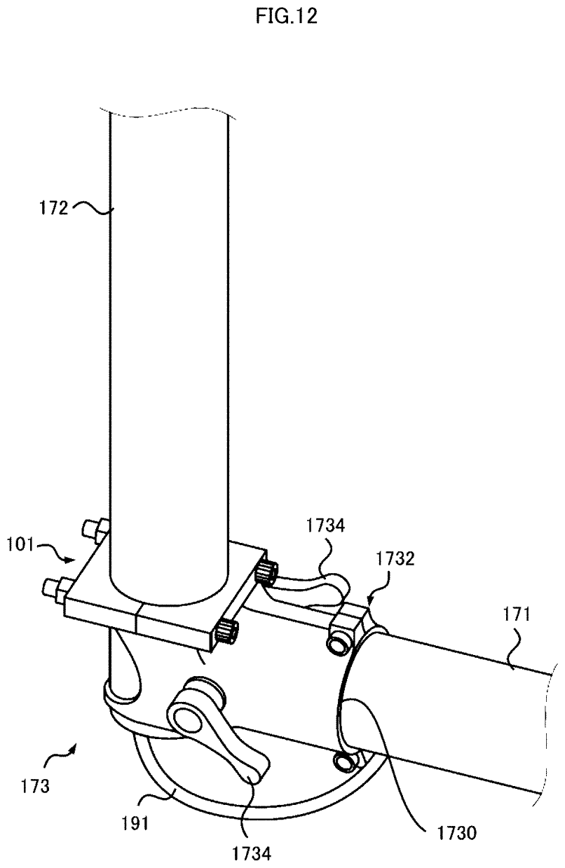

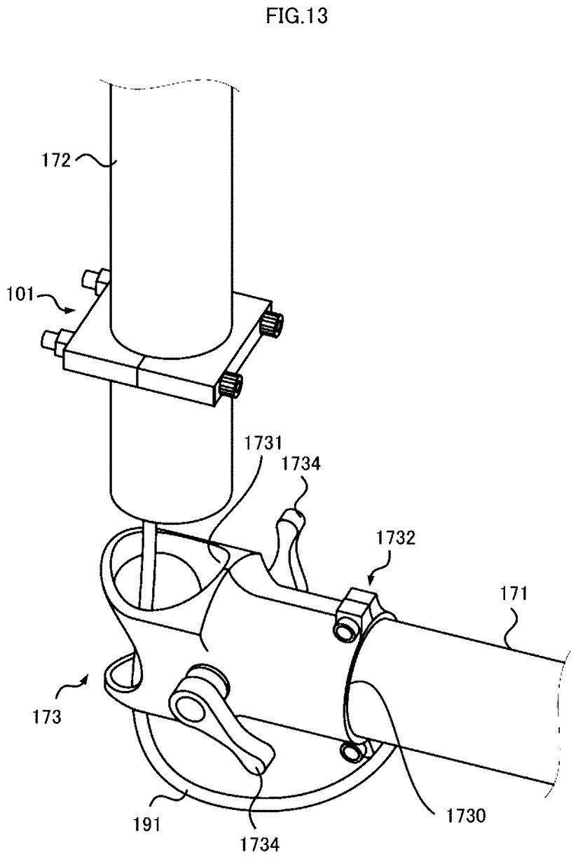

FIG. 12 is an enlarged perspective view of a vicinity of the bar-like-member coupling portion 173 of the arm portion 17, which illustrates the state in which the first bar-like member 171 and the second bar-like member 172 are coupled to each other with the bar-like-member coupling portion 173. FIG. 13 is another enlarged perspective view of the vicinity of the bar-like-member coupling portion 173 of the arm portion 17, which illustrates a state in which the first bar-like member 171 and the second bar-like member 172 are separated from each other.

The first bar-like member 171 and the second bar-like member 172, each of which is, for example, a tubular body having a circular shape in cross-section, is made of a lightweight and rigid material such as carbon fibers.

As illustrated in FIG. 12 and FIG. 13, the bar-like-member coupling portion 173 has an insertion hole 1730 in which the other end portion of the first bar-like member 171 is inserted, and an insertion hole 1731 in which the end other portion of the second bar-like member 172 is inserted. The insertion hole 1730 and the insertion hole 1731 are orthogonal to each other, and hence the first bar-like member 171 and the second bar-like member 172 inserted in these holes are coupled to each other in the L-shape.

The bar-like-member coupling portion 173 is split substantially at a center of the insertion hole 1730 in a longitudinal direction (the direction parallel to the virtual center line VL). When screws of fasteners 1732 provided to a rim portion of the insertion hole 1730 are turned with a tool, the insertion hole 1730 radially expands or shrinks. With this, the first bar-like member 171 can be coupled in a separable manner to the bar-like-member coupling portion 173.

Further, a fastening screw 1734 penetrates an intermediate part between the insertion hole 1730 and the insertion hole 1731 of the bar-like-member coupling portion 173 in a direction perpendicular to the insertion hole 1731. When levers at both ends of the fastening screw 1734 are turned, an interval between the levers at both the ends varies to cause the insertion hole 1731 to radially expand or shrink. Thus, as illustrated in FIG. 12 and FIG. 13, the second bar-like member 172 can be easily attached to and detached from the bar-like-member coupling portion 173.

In the example of FIG. 13, an attachable/detachable retainer 101 is provided around an outer surface of a vicinity of the other end portion of the second bar-like member 172. By providing the retainer 101, an insertion depth of the second bar-like member 172 with respect to the insertion hole 1731 of the bar-like-member coupling portion 173 is substantially kept constant. Thus, positional relationships between the antennas 19 are likely to be maintained, and hence errors in estimating the position and the posture can be reduced.

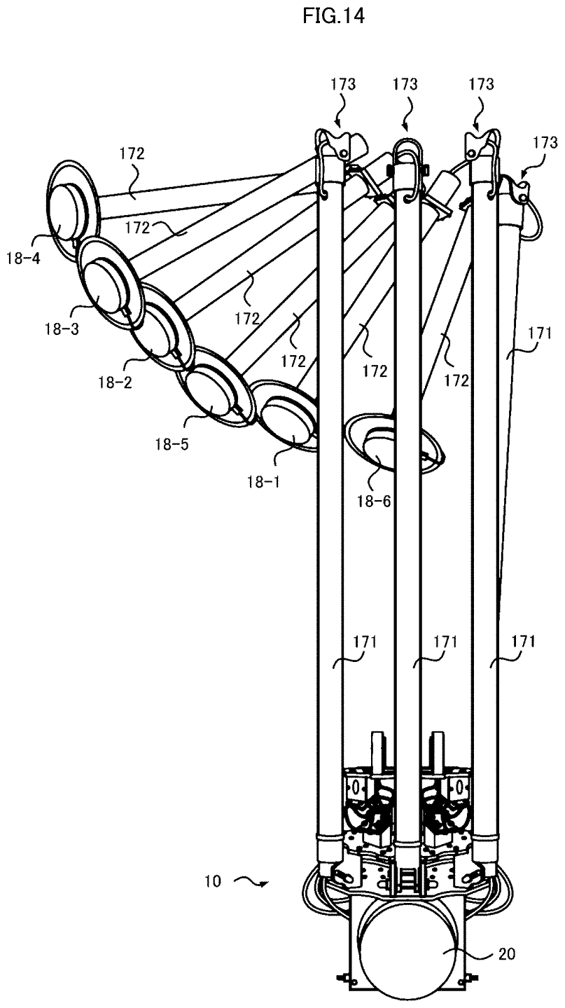

FIG. 14 is a view illustrating a state in which the arm portions 17 of the information collection apparatus 10 are folded. In the state of FIG. 14, the first bar-like members 171 of the arm portions 17 are folded in a direction substantially parallel to the virtual center line VL, and the second bar-like members 172 of the arm portions 17 are separated from the bar-like-member coupling portions 173.

### SUMMARY

According to this embodiment, the advantages as described below can be obtained.

(1) The six receivers 18 each receive the location signals that are broadcasted from the satellites 7. Thus, even without use of the IMU, by using these signals received by the receivers 18, the position and the posture of the information collection apparatus 10 can be estimated with high accuracy. Further, the six antennas 19 that receive the location signals are arranged in the annular array and at the equal intervals. With this, the number of pairs of the antennas 19, which are distant from each other, increases, and hence accuracy in estimating the posture is increased. In addition, in the annular array, the pairs of the antennas 19, which are distant from each other, are not intensively formed on a particular side. Thus, a variation in estimating the posture in accordance with turning (roll, pitch, and yaw) directions of the posture is likely to be suppressed.

(2) The six antennas 19 are fixed respectively to the one ends of the six arm portions 17 each extending in the direction away from the virtual center line VL that extends through the body portion 12. Thus, the six antennas 19 can be arranged in the annular array with the frame 11 having a lightweight and simple structure.

(3) The arm-portion support mechanisms 14 of the body portion 12 each support the other end of the arm portion 17 in the pivotal manner such that the angle of the arm portion 17 with respect to the virtual center line VL can be varied. Thus, by varying the angle of each of the arm portions 17 in a manner that the six arm portions 17 come close to the virtual center line VL, the frame 11 is made compact as a whole. With this, the information collection apparatus 10 is easily accommodated and carried.

(4) When the six arm-portion support mechanisms 14 are held in the locking state, the six antennas 19 are arranged in the annular array. With this, the errors in estimating the position and in estimating the posture due to the variations of the angles of the arm portions 17 with respect to the virtual center line VL are suppressed.

(5) The drone 24, which is located on the virtual center line VL, is coupled to the body portion 12. With this, even when the drone 24 moves under the state in which the drone 24 and the body portion 12 are coupled to each other, a weight of the body portion 12 and a weight of the drone 24 scarcely influence the six arm portions 17. Thus, deflection and distortion of the arm portions 17 due to the weights of the body portion 12 and the drone 24 are likely to be avoided. Further, a center of gravity of the information collection apparatus 10 is located substantially at the body portion 12 through which the virtual center line VL extends. Thus, when the drone 24 is coupled to a vicinity of the center of gravity of the information collection apparatus 10, the posture of the information collection apparatus 10 is likely to be stabilized. In addition, the body portion 12 and the drone 24 are coupled in the attachable/detachable manner to each other. With this, the information collection apparatus 10 is easily accommodated and carried.

(6) The six antennas 19 are located in the virtual plane VP perpendicular to the virtual center line VL, and the virtual plane VP is spaced away from the drone 24 under the state of being coupled to the mobile-body coupling portion 16. Thus, when the information collection apparatus 10 is used in a manner that the virtual center line VL is substantially parallel to a vertical direction, and that the virtual plane VP is located above the drone 24, the reception of the signals from the satellites 7 via the six antennas 19 is not liable to be hindered by the drone 24.

(7) Even when the body portion 12 is suspended from the drone 24, the six antennas 19 can be arranged above the drone 24 by the structures which are lightweight and simple and each of which couples the first bar-like member 171 and the second bar-like member 172 to each other in the L-shape.

(8) The first bar-like members 171 and the second bar-like members 172 can be separated from each other, and hence the information collection apparatus 10 can be easily accommodated and carried.

(9) The body frame 13 that supports the other ends of the six arm portions 17, and the mobile-body coupling portion 16 are fixed to the vibration-damping portion 15. Thus, the transmission of the vibration from the mobile-body coupling portion 16 to the body frame 13 is suppressed by the vibration-damping portion 15. Therefore, vibration generated by the drone 24 is not liable to be transmitted to the antennas 19 or the receivers 18. With this, influence that the transmission of the vibration to the antennas 19 and the receivers 18 may have on the received signals can be reduced.

(10) The body frame 13 and the mobile-body coupling portion 16 are connected to each other with the plurality of wires 151. With such a simple configuration, the transmission of the vibration to the body frame 13 can be suppressed. Further, when the body frame 13 and the mobile-body coupling portion 16 are connected to each other with the plurality of wires 151, the body frame 13 and the mobile-body coupling portion 16 can be coupled to each other with sufficient strength.

(11) The six arm-portion support mechanisms 14, each of which supports the other end of the arm portion 17, are arranged between the first plate-like member 131 and the second plate-like member 132. With such lightweight and simple structures, the six arm portions 17 can be supported. Further, the third plate-like member 161 of the mobile-body coupling portion 16 and the first plate-like member 131 face each other, and the transmission of the vibration therebetween is suppressed by the vibration-damping portion 15. In this way, a vibration-damping structure can be provided over a large area in a region where the third plate-like member 161 and the first plate-like member 131 face each other. As a result, satisfactory vibration-damping performance can be exhibited.

(12) By providing the ranging apparatus 20, the distance to the target is measured in synchronization with the reception of the location signals by the six receivers 18. Thus, based on the results of the estimation of the position and the posture of the UAV 1, and on the results of the distance measurement by the ranging apparatus 20, a precise three-dimensional data item of the target can be obtained.

The present disclosure is not limited the embodiment described hereinabove, and may be carried out in various forms.

The number of the (six) receivers 18 that are installed in the UAV 1 (information collection apparatus 10) in the embodiment described hereinabove is merely an example, and hence is not limited thereto as long as fewest-possible three or more receivers 18 for enabling the posture estimation are provided.

In the example of FIG. 13, the cable 191 remains connected even under the state in which the bar-like-member coupling portion 173 and the second bar-like member 172 are separated from each other. As another example of this embodiment, a connector may be provided partway around the cable 191 such that the cable 191 also can be disconnected under the state in which the bar-like-member coupling portion 173 and the second bar-like member 172 are separated from each other.

In the structure of the embodiment described hereinabove, the arm portions 17 can be folded with respect to the body portion 12. As another example of this embodiment, the arm portions 17 may be attached to and detached from the body portion 12. Also in this case, the connector may be provided partway around the cable 191 such that the cable 191 also can be disconnected.

The information collection apparatus 10 is installed in the UAV 1 in the example of the embodiment described hereinabove, but the mobile body in the present disclosure is not limited to the UAV. As other examples of the mobile body, there may be mentioned a vehicle that travels on the ground, and a ship that sails on the sea. In addition, the mobile body is not limited to unmanned vehicles, and may be vehicles that move with a person riding thereon.

The present disclosure is not limited to the example of the embodiment described hereinabove, in which the UAV 1 that flies in the air includes the ranging apparatus 20 such as the laser scanner, and generates the three-dimensional map by utilizing the results of the measurement by the ranging apparatus 20 and the results of the estimation of the position and the posture. As another example of the present disclosure, a camera that captures the ground surface may be installed instead of the ranging apparatus 20. In addition, the results of the estimation of the position and the posture of the mobile body may be utilized for various measurements other than the surveying, or may be utilized for purposes other than the measurements (such as a purpose of automatically recording and controlling the position and the posture of the mobile body, and a purpose of precisely estimating its orientations).

Below, appendices of this embodiment are described.

### APPENDIX 1

An information collection apparatus (10) that collects information items about a position and a posture, the information collection apparatus (10) comprising:

“N” (N is an integer number of three or more) receivers (18-1 to 18-6), the “N” receivers (18-1 to 18-6) each receiving location signals that are broadcasted from a plurality of satellites (7); and

a frame (11) to which “N” antennas (19-1 to 19-6) of the “N” receivers (18-1 to 18-6) are fixed,

the “N” antennas (19-1 to 19-6) of the “N” receivers (18-1 to 18-6) receiving the location signals, and being arranged in an annular array and at equal intervals,

the frame (11) including
a body portion (12), and
“N” arm portions (17-1 to 17-6), the “N” arm portions (17-1 to 17-6) each extending in a direction away from a virtual center line (VL) that extends through the body portion (12),

the “N” antennas (19-1 to 19-6) being fixed respectively to one ends of the “N” arm portions (17-1 to 17-6), the one ends being away from the body portion (12),

the body portion (12) including
a body frame (13) that supports other ends of the “N” arm portions (17-1 to 17-6),
a mobile-body coupling portion (16) that is coupled in an attachable/detachable manner to a mobile body (1) that is located on the virtual center line (VL), and
a vibration-damping portion (15) that is fixed to the body frame (13) and the mobile-body coupling portion (16), and that suppresses transmission of vibration from the mobile-body coupling portion (16) to the body frame (13),

the “N” antennas (19-1 to 19-6) being located in a common virtual plane (VP) perpendicular to the virtual center line (VL),

the common virtual plane (VP) being spaced away from the mobile body (1) under a state of being coupled to the mobile-body coupling portion (16),

when the virtual center line (VL) is parallel to a vertical direction, and at a same time, when the common virtual plane (VP) is located above the mobile body (1), the body frame (13) being suspended from the mobile body (1) through intermediation of the vibration-damping portion (15) and the mobile-body coupling portion (16).

According to the information collection apparatus (10), the “N” receivers (18-1 to 18-6) each receive the location signals that are broadcasted from the satellites (7). Thus, even without use of the IMU, by using these signals received by the receivers (18-1 to 18-6), the position and the posture of the information collection apparatus (10) can be estimated with high accuracy. Further, the “N” antennas (19-1 to 19-6) that receive the location signals are arranged in the annular array and at the equal intervals. With this, the number of pairs of the antennas (19-1 to 19-6), which are distant from each other, increases, and hence accuracy in estimating the posture is increased. In addition, in the annular array, the pairs of the antennas (19-1 to 19-6), which are distant from each other, are not intensively formed on a particular side. Thus, a variation in estimating the posture in accordance with turning (roll, pitch, and yaw) directions of the posture is likely to be suppressed.

Further, according to the information collection apparatus (10), the “N” antennas (19-1 to 19-6) are fixed respectively to the one ends of the “N” arm portions (17-1 to 17-6) each extending in the direction away from the virtual center line (VL) that extends through the body portion (12). Thus, the “N” antennas (19-1 to 19-6) can be arranged in the annular array with the frame (11) having a lightweight and simple structure.

Still further, according to the information collection apparatus (10), the mobile body (1), which is located on the virtual center line (VL), is coupled to the body portion (12). With this, even when the mobile body (1) moves under the state in which the mobile body (1) and the body portion (12) are coupled to each other, a weight of the body portion (12) and a weight of the mobile body (1) scarcely influence the “N” arm portions (17-1 to 17-6). Thus, deflection and distortion of the arm portions (17-1 to 17-6) due to the weights of the body portion (12) and the mobile body (1) are likely to be avoided. Further, a center of gravity of the information collection apparatus (10) is located substantially at the body portion (12) through which the virtual center line (VL) extends. Thus, when the mobile body (1) is coupled to a vicinity of the center of gravity of the information collection apparatus (10), the posture of the information collection apparatus (10) is likely to be stabilized. In addition, the body portion (12) and the mobile body (1) are coupled in the attachable/detachable manner to each other. With this, the information collection apparatus (10) is easily accommodated and carried.

Yet further, according to the information collection apparatus (10), the body frame (13) that supports the other ends of the “N” arm portions (17-1 to 17-6), and the mobile-body coupling portion (16) are fixed to the vibration-damping portion (15). Thus, the transmission of the vibration from the mobile-body coupling portion (16) to the body frame (13) is suppressed by the vibration-damping portion (15). Therefore, vibration generated by the mobile body (1) is not liable to be transmitted to the antennas (19-1 to 19-6) or the receivers (18-1 to 18-6). With this, influence that the transmission of the vibration to the antennas (19-1 to 19-6) and the receivers (18-1 to 18-6) may have on the received signals can be reduced.

Yet further, according to the information collection apparatus (10), when the posture of the information collection apparatus (10) is set such that the virtual center line (VL) is substantially parallel to the vertical direction, and that the virtual plane (VP) is located above the mobile body (1), the reception of the signals from the satellites (7) via the “N” antennas (19-1 to 19-6) is not liable to be hindered by the mobile body (1).

Further, in this state, the body frame (13) is suspended from the mobile body (1) through intermediation of the vibration-damping portion (15) and the mobile-body coupling portion (16), and hence a position of the center of gravity of the information collection apparatus (10) as a whole is lowered. Thus, even under the state in which the “N” antennas (19-1 to 19-6) are located above the mobile body (1), a posture of the mobile body (1) coupled to the body frame (13) is likely to be stabilized.

Still further, in this case, the vibration-damping portion (15) is interposed between the body frame (13) and the mobile body (1), and hence there is an advantage that the vibration to be transmitted from the mobile body (1) to the “N” antennas (19-1 to 19-6) and the receivers (18-1 to 18-6) via the body frame (13) can be reduced.

Yet further, according to the information collection apparatus (10), due to the structure in which the vibration-damping portion (15) is interposed between the body frame (13) and the mobile body (1), the number of vibration-damping components can be reduced to be smaller than that in a case where a vibration-damping member is provided to each of the “N” antennas (19-1 to 19-6) and the receivers (18-1 to 18-6). As a result, structural simplification can be achieved. In addition, relative positional relationships between the antennas (19-1 to 19-6) are not varied even by a vibration-damping effect, and hence errors in estimating the position and the posture can be suppressed to be significantly small.

### APPENDIX 2

The information collection apparatus (10) according to Appendix 1, wherein the “N” arm portions (17-1 to 17-6) each include

a first bar-like member (171) that has one end supported by the body portion (12), and that extends parallel to the common virtual plane (VP),

a second bar-like member (172) that has one end to which corresponding one of the “N” antennas (19-1 to 19-6) is fixed, and that extends perpendicular to the common virtual plane (VP), and

a bar-like-member coupling portion (173) that couples the first bar-like member (171) and the second bar-like member (172) to each other in an L-shape.

With this configuration, that is, by the structures which are lightweight and simple and each of which couples the first bar-like member (171) and the second bar-like member (172) to each other in the L-shape, even when the body portion (12) is suspended from the mobile body (1), the “N” antennas (19-1 to 19-6) can be arranged above the mobile body (1).

### APPENDIX 3

The information collection apparatus (10) according to Appendix 2, wherein the bar-like-member coupling portion (173) couples the first bar-like member (171) and the second bar-like member (172) in a separable manner to each other.

With this configuration, the first bar-like member (171) and the second bar-like member (172) can be separated from each other, and hence the information collection apparatus (10) can be easily accommodated and carried.

### APPENDIX 4

The information collection apparatus (10) according to any one of Appendices 1 to 3,

wherein the body frame (13) includes
a first plate-like member (131),
a second plate-like member (132), the first plate-like member (131) and the second plate-like member (132) being arranged to face each other, and
“N” arm-portion support mechanisms (14) that are arranged between the first plate-like member (131) and the second plate-like member (132), and that respectively support the other ends of the “N” arm portions (17-1 to 17-6),

wherein the mobile-body coupling portion (16) includes a third plate-like member (161) arranged to face the first plate-like member (131), and

wherein the vibration-damping portion (15) suppresses the transmission of the vibration from the third plate-like member (161) to the first plate-like member (131).

In this configuration, the “N” arm-portion support mechanisms (14) that respectively support the other ends of the arm portions (17-1 to 17-6) are arranged between the first plate-like member (131) and the second plate-like member (132). With such lightweight and simple structures, the “N” arm portions (17-1 to 17-6) can be supported. Further, the third plate-like member (161) of the mobile-body coupling portion (16) and the first plate-like member (131) face each other, and the transmission of the vibration therebetween is suppressed by the vibration-damping portion (15). In this way, a vibration-damping structure can be provided over a large area in a region where the third plate-like member (161) and the first plate-like member (131) face each other. As a result, satisfactory vibration-damping performance is likely to be exhibited.

### APPENDIX 5

An information collection apparatus (10) that collects information items about a position and a posture, the information collection apparatus (10) comprising:

“N” (N is an integer number of three or more) receivers (18-1 to 18-6), the “N” receivers (18-1 to 18-6) each receiving location signals that are broadcasted from a plurality of satellites (7); and

a frame (11) to which “N” antennas (19-1 to 19-6) of the “N” receivers (18-1 to 18-6) are fixed,

the “N” antennas (19-1 to 19-6) of the “N” receivers (18-1 to 18-6) receiving the location signals, and being arranged in an annular array and at equal intervals,

the frame (11) including
a body portion (12), and
“N” arm portions (17-1 to 17-6), the “N” arm portions (17-1 to 17-6) each extending in a direction away from a virtual center line (VL) that extends through the body portion (12),

the “N” antennas (19-1 to 19-6) being fixed respectively to one ends of the “N” arm portions (17-1 to 17-6), the one ends being away from the body portion (12),

the body portion (12) including
a body frame (13) that supports other ends of the “N” arm portions (17-1 to 17-6),
a mobile-body coupling portion (16) that is coupled in an attachable/detachable manner to a mobile body (1) that is located on the virtual center line (VL), and
a vibration-damping portion (15) that is fixed to the body frame (13) and the mobile-body coupling portion (16), and that suppresses transmission of vibration from the mobile-body coupling portion (16) to the body frame (13),

the body frame (13) including
a first plate-like member (131),
a second plate-like member (132), the first plate-like member (131) and the second plate-like member (132) being arranged to face each other, and
“N” arm-portion support mechanisms (14) that are arranged between the first plate-like member (131) and the second plate-like member (132), and that respectively support the other ends of the “N” arm portions (17-1 to 17-6),

the “N” arm-portion support mechanisms (14) each including a support (145) fixed to the first plate-like member (131) and the second plate-like member (132),

the mobile-body coupling portion (16) including a third plate-like member (161) arranged to face the first plate-like member (131),

the vibration-damping portion (15) suppressing the transmission of the vibration from the third plate-like member (161) to the first plate-like member (131).

According to the information collection apparatus (10), the “N” arm-portion support mechanisms (14) each have a function to support the other end of corresponding one of the “N” arm portions (17-1 to 17-6), and each have a function to fix the support (145) and a pair of the first plate-like member (131) and the second plate-like member (132) to each other. In other words, the “N” arm-portion support mechanisms (14) each not only have a function to support corresponding one of the “N” arm portions (17-1 to 17-6), but also have a function to support the structure of the body frame (13) including the first plate-like member (131) and the second plate-like member (132). Thus, despite the relatively simple structure, strength necessary for the body frame (13) can be secured. In addition, the number of the components of the body frame (13) can be reduced to achieve weight reduction.

Further, according to the information collection apparatus (10), the third plate-like member (161) of the mobile-body coupling portion (16) is arranged to face the first plate-like member (131). When the third plate-like member (161) is coupled to the mobile body (1), the transmission of the vibration from the third plate-like member (161) to the first plate-like member (131) is suppressed by the vibration-damping portion (15). Thus, the large area is likely to be secured at the part where the third plate-like member (161) and the first plate-like member (131) face each other, and a vibration-damping structure having satisfactory vibration-damping performance is likely to be provided with use of this large area.

Still further, according to the information collection apparatus (10), due to the structure in which the vibration-damping portion (15) is interposed between the body frame (13) and the mobile body (1), the number of vibration-damping components can be reduced to be smaller than that in the case where the vibration-damping member is provided to each of the “N” antennas (19-1 to 19-6) and the receivers (18-1 to 18-6). As a result, structural simplification can be achieved. In addition, the relative positional relationships between the antennas (19-1 to 19-6) are not varied even by the vibration-damping effect, and hence a significantly great advantage that the errors in estimating the position and the posture can be suppressed to be significantly small is obtained.

### APPENDIX 6

The information collection apparatus (10) according to any one of Appendices 1 to 5, wherein the vibration-damping portion (15) includes a plurality of wires (151) that connect the body frame (13) and the mobile-body coupling portion (16) to each other.

With this configuration, despite its simplicity, the transmission of the vibration to the body frame (13) can be suppressed. Further, the body frame (13) and the mobile-body coupling portion (16) are connected to each other with the plurality of wires (151), and hence the body frame (13) and the mobile-body coupling portion (16) are coupled to each other with sufficient strength.

### APPENDIX 7

The information collection apparatus (10) according to any one of Appendices 1 to 6,

wherein the body portion (12) includes the “N” arm-portion support mechanisms (14) that respectively support the other ends of the “N” arm portions (17-1 to 17-6), and

wherein the “N” arm-portion support mechanisms (14) respectively support the other ends of the “N” arm portions (17-1 to 17-6) in a pivotal manner such that angles of the “N” arm portions (17-1 to 17-6) with respect to the virtual center line (VL) can be varied.

In this configuration, the arm-portion support mechanisms (14) of the body portion (12) respectively support the other ends of the arm portions (17-1 to 17-6) in the pivotal manner such that the angles of the arm portions (17-1 to 17-6) with respect to the virtual center line (VL) can be varied. Thus, by varying the angles of the “N” arm portions (17-1 to 17-6) in a manner that the arm portions (17-1 to 17-6) come close to the virtual center line (VL), the frame (11) is made compact as a whole. With this, the information collection apparatus (10) is easily accommodated and carried.

### APPENDIX 8

The information collection apparatus (10) according to Appendix 7,

wherein, when the angle of one of the “N” arm portions (17-1 to 17-6) with respect to the virtual center line (VL) reaches a predetermined angle, corresponding one of the “N” arm-portion support mechanisms (14) enters a locking state in which the one of the “N” arm portions (17-1 to 17-6) is stopped from pivoting,

wherein the locking state can be cancelled, and

wherein, when the “N” arm-portion support mechanisms (14) are each held in the locking state, the “N” antennas (19-1 to 19-6) are arranged in the annular array.

With this configuration, when the “N” arm-portion support mechanisms (14) are each held in the locking state, the “N” antennas (19-1 to 19-6) are arranged in the annular array. With this, the errors in estimating the position and in estimating the posture due to the variations of the angles of the arm portions (17-1 to 17-6) with respect to the virtual center line (VL) are suppressed.

### APPENDIX 9

The information collection apparatus (10) according to any one of Appendices 1 to 8, further comprising a ranging apparatus (20) that measures a distance to a target in synchronization with the reception of the location signals by the “N” receivers (18-1 to 18-6).

With this configuration, based on results of the estimation of the position and the posture of the mobile body (1), and on results of the distance measurement by the ranging apparatus (20), a precise three-dimensional data item of the target can be obtained.

### APPENDIX 10

An unmanned aerial vehicle (1) in which the information collection apparatus (10) according to any one of Appendices 1 to 9 is installed.

### REFERENCE SIGNS LIST

1 UAV
10 information collection apparatus
101 retainer
11 frame
12 body portion
13 body frame
131 first plate-like member
132 second plate-like member
14 arm-portion support mechanism
141 shaft
142 engaging pin
143 spring
144 bar holder
145 support
146 engaging groove
15 vibration-damping portion
151 wire
152, 153 wire fastener
16 mobile-body coupling portion
161 third plate-like member
162A, 162B coupler
17-1 to 17-6 arm portion
171 first bar-like member
172 second bar-like member
173 bar-like-member coupling portion
18-1 to 18-6, 18A receiver
19-1 to 19-6, 19A antenna
20 ranging apparatus
21 control apparatus
22 processing unit
23 storage unit
24 drone
25 body portion
26-1 to 26-6 propeller
27-1 to 27-6 arm portion
3 terrestrial reference station
5 information processing apparatus
51 interface unit
52 display unit
53 processing unit
531 posture estimation unit
532 position estimation unit
533 three-dimensional-map generating unit
54 storage unit
541 program
7 satellite
9 ground surface

1-10. (canceled)

11. An information collection apparatus that collects information items about a position and a posture, the information collection apparatus comprising:
“N” (N is an integer number of three or more) receivers, the “N” receivers each receiving location signals that are broadcasted from a plurality of satellites; and
a frame to which “N” antennas of the “N” receivers are fixed,
the “N” antennas of the “N” receivers receiving the location signals, and being arranged in an annular array and at equal intervals,
the frame including
a body portion, and
“N” arm portions, the “N” arm portions each extending in a direction away from a virtual center line that extends through the body portion,
the “N” antennas being fixed respectively to one ends of the “N” arm portions, the one ends being away from the body portion,
the body portion including
a body frame that supports other ends of the “N” arm portions,
a mobile-body coupling portion that is coupled in an attachable/detachable manner to a mobile body that is located on the virtual center line, and
a vibration-damping portion that is fixed to the body frame and the mobile-body coupling portion, and that suppresses transmission of vibration from the mobile-body coupling portion to the body frame,
the “N” antennas being located in a common virtual plane perpendicular to the virtual center line,
the common virtual plane being spaced away from the mobile body under a state of being coupled to the mobile-body coupling portion,
when the virtual center line is parallel to a vertical direction, and at a same time, when the common virtual plane is located above the mobile body, the body frame being suspended from the mobile body through intermediation of the vibration-damping portion and the mobile-body coupling portion.

12. The information collection apparatus according to claim 11, wherein the “N” arm portions each include
a first bar-like member that has one end supported by the body portion, and that extends parallel to the common virtual plane,
a second bar-like member that has one end to which corresponding one of the “N” antennas is fixed, and that extends perpendicular to the common virtual plane, and
a bar-like-member coupling portion that couples the first bar-like member and the second bar-like member to each other in an L-shape.

13. The information collection apparatus according to claim 12, wherein the bar-like-member coupling portion couples the first bar-like member and the second bar-like member in a separable manner to each other.

14. The information collection apparatus according to claim 11,
wherein the body frame includes
a first plate-like member,
a second plate-like member, the first plate-like member and the second plate-like member being arranged to face each other, and
“N” arm-portion support mechanisms that are arranged between the first plate-like member and the second plate-like member, and that respectively support the other ends of the “N” arm portions,
wherein the mobile-body coupling portion includes a third plate-like member arranged to face the first plate-like member, and
wherein the vibration-damping portion suppresses the transmission of the vibration from the third plate-like member to the first plate-like member.

15. An information collection apparatus that collects information items about a position and a posture, the information collection apparatus comprising:
“N” (N is an integer number of three or more) receivers, the “N” receivers each receiving location signals that are broadcasted from a plurality of satellites; and
a frame to which “N” antennas of the “N” receivers are fixed,
the “N” antennas of the “N” receivers receiving the location signals, and being arranged in an annular array and at equal intervals,
the frame including
a body portion, and
“N” arm portions, the “N” arm portions each extending in a direction away from a virtual center line that extends through the body portion,
the “N” antennas being fixed respectively to one ends of the “N” arm portions, the one ends being away from the body portion,
the body portion including
a body frame that supports other ends of the “N” arm portions,
a mobile-body coupling portion that is coupled in an attachable/detachable manner to a mobile body that is located on the virtual center line, and
a vibration-damping portion that is fixed to the body frame and the mobile-body coupling portion, and that suppresses transmission of vibration from the mobile-body coupling portion to the body frame,
the body frame including
a first plate-like member,
a second plate-like member, the first plate-like member and the second plate-like member being arranged to face each other, and
“N” arm-portion support mechanisms that are arranged between the first plate-like member and the second plate-like member, and that respectively support the other ends of the “N” arm portions,
the “N” arm-portion support mechanisms each including a support fixed to the first plate-like member and the second plate-like member,
the mobile-body coupling portion including a third plate-like member arranged to face the first plate-like member,
the vibration-damping portion suppressing the transmission of the vibration from the third plate-like member to the first plate-like member.

16. The information collection apparatus according to claim 11, wherein the vibration-damping portion includes a plurality of wires that connect the body frame and the mobile-body coupling portion to each other.

17. The information collection apparatus according to claim 11,
wherein the body portion includes the “N” arm-portion support mechanisms that respectively support the other ends of the “N” arm portions, and
wherein the “N” arm-portion support mechanisms respectively support the other ends of the “N” arm portions in a pivotal manner such that angles of the “N” arm portions with respect to the virtual center line can be varied.

18. The information collection apparatus according to claim 17,
wherein, when the angle of one of the “N” arm portions with respect to the virtual center line reaches a predetermined angle, corresponding one of the “N” arm-portion support mechanisms enters a locking state in which the one of the “N” arm portions is stopped from pivoting,
wherein the locking state can be cancelled, and
wherein, when the “N” arm-portion support mechanisms are each held in the locking state, the “N” antennas are arranged in the annular array.

19. The information collection apparatus according to claim 11, further comprising a ranging apparatus that measures a distance to a target in synchronization with the reception of the location signals by the “N” receivers.

20. An unmanned aerial vehicle in which the information collection apparatus according to claim 11 is installed.
